(19) United States
(12) Patent Application Publication
(10) Pub. No.: US 2006/0207367 A1
(43) Pub. Date: Sep. 21, 2006

(54) Torsion disc and the technology of using them

(76) Inventor: Richard Duane Walton, Clackamas, OR (US)

Correspondence Address: Richard Duane Walton, PO Box 2731, Clackamas, OR, 97015, US

(21) Appl. No.: 11/374,962

(22) Filed: Mar. 15, 2006

Related U.S. Application Data
(60) Provisional application No. 60/661,881, filed on Mar. 16, 2005.

(51) Int. Cl. F16H 35/00

(52) U.S. Cl. 74/380

(57) ABSTRACT

An energy-producing device, examples of shown in FIGS. 1A to 1D, FIG. 2, and FIG. 3A, and a technology for significant energy production.

### CROSS-REFERENCE TO RELATED APPLICATIONS

This application claims the benefit of provisional patent application Ser. No. 60/661,881, filed 2005 Mar. 16 by present inventor.

### FEDERALLY SPONSORED RESEARCH

Not Applicable

### SEQUENCE LISTING OR PROGRAM

Not Applicable

### BACKGROUND OF THE INVENTION

### Field of the Invention

This invention relates to the field of energy, specifically an energy-producing device and a technology for producing energy.

### Prior Art

No Prior Art

Accordingly several objects and advantages of the present invention are:

(a) to provide a technology which will enable the production of power systems of any practical size which require no fuel to operate;

(b) to provide a technology which will enable the production of large power plants without the need for dams, fossil fuels, nuclear power, the sun, the wind, and without concerns about waste disposal;

(c) to provide a technology which will enable the production of portable generators which need no fuel to operate and that can be operated in enclosed areas without concerns about dangerous exhaust;

(d) to provide a technology which, though this technology can be used with fuel systems, is an excellent alternative to fuel for automobiles, trucks, boats, ships, or any machine and without the need for any fuel;

(e) to provide a technology which, for many practical rea- sons, is an excellent unlimited source of clean energy.

### SUMMARY

In accordance with the present invention a technology for producing energy and a method for using an energy-producing de- vice for significant energy production.

### DRAWINGS

### Figures

In the drawings, closely related figures have the same number but different alphabetic suffixes.

FIGS. A to D show various aspects of a torsion disc.

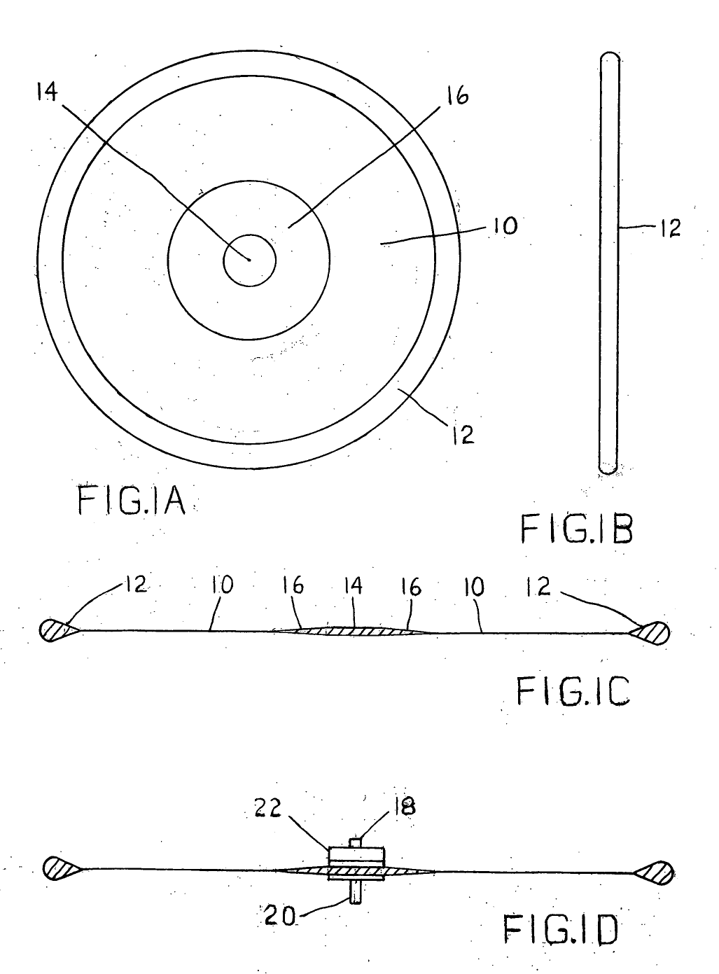

FIG. 2 shows a similar but slightly different torsion disc than that shown in FIGS. 1A to 1D.

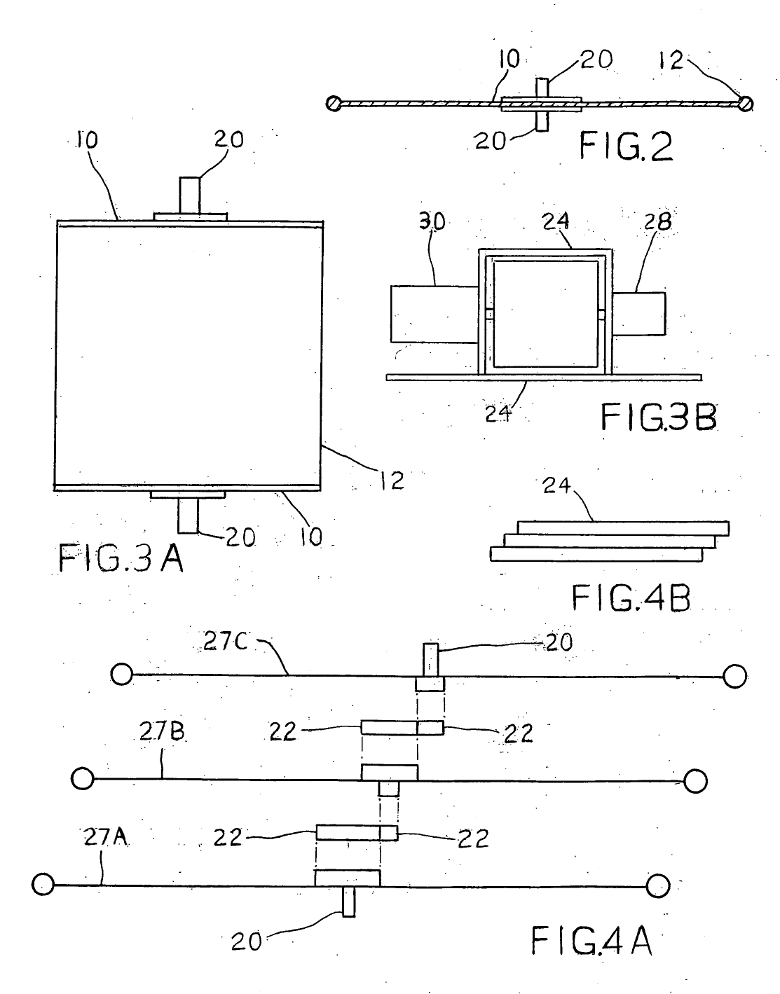

FIG. 3A shows a can-like torsion disc.

FIG. 3B shows a simple way to use a single torsion disc using the torsion disc in FIG. 3A as an example.

FIG. 4A shows a simple way to use multiple torsion discs.

FIG. 4B shows an enclosure.

### Reference Numerals

| | | | |
|---|---|---|---|
| 10 | basic disc | 12 | outer-rim weight |
| 14 | optional thicker center | 16 | optional tapering |
| 18 | pivot-shaft | 20 | drive-shaft |
| 22 | gear | 24 | mount brace safety |
| 26 | pivot-bearing or bushing | | enclosure |
| 28 | motor | 27 | disc in FIGS. 1A to 1D |
| | | 30 | generator |

### DETAILED DESCRIPTION

### Preferred Embodiment

A basic version of my torsion disc is illustrated in FIG. 1A (top or side view), FIG. 1B (end view), FIG. 1C (center cross-section view) and FIG. 1D (center cross-section view) which has the outlines of a pivot-shaft 18, a drive-shaft 20 and a gear 22. This particular torsion disc is basically a 48″×⅛″ flat, round, steel disc 10 with 120 pounds of steel outer-rim weight 12. This outer-rim weight is distributed evenly and symmetrically around and extending about 1 ¼″ outward from the 2 foot radius of this disc and extending inward from the 2 foot radius, or so that the average or balance of this 120 pounds of outer-rim weight 12 is at the 2 foot radius of this disc 10. This outer-rim weight 12 on this torsion disc, if looking at it from a center cross-section view as in FIG. 1C, appears as teardrop shaped. This shape is variable and optional on a torsion disc. The amount of outer-rim weight on a torsion disc is also variable or optional. The center 6″ of this torsion disc is ¼″ thick 14 with the next 6″ tapering 16 away symmetrically thinner from the center 6″ back to the basic ⅛″ thickness of this torsion disc. This amount of center thickness 14 and tapering 16 is variable or optional on a torsion disc depending on the strength or quality of the steel or material being used. FIG. 2 shows a center cross-section view of a steel 25″×¼inch torsion disc comprising a flat, round 24″×¼″ steel disc 10 with 30 pounds of steel outer-rim weight attached and distributed evenly and symmetrically around and at the 1 foot radius of this disc 10. Also shown in FIG. 2 are the outlines of two drive-shafts 20.

FIG. 3A shows a side view of a steel, can-like device comprising two steel discs 10, about 12.36″×¼″ each, and each weighing about 7.5 pounds. Attached and sandwiched between these two discs is a 45 pound steel cylinder 12, about 12.36″×12″×.36″. Also shown are two drive-shafts 20, one attached and centered on a disc at each end of the device. FIG. 3B shows this can-like device, for comprehension of operation, in a mount brace safety enclosure 24. This enclosure has holes (not shown) to allow the drive-shafts of the device to go through and connect with an attached motor on the other side of the enclosure on one end, and an attached generator at the other end and on the other side of the enclosure 24.

FIG. 4A is a schematic-like drawing with 3 of the 48″×⅛″ torsion discs described in FIGS. 1A to 1D with gears 22, pivot-shafts 18 and drive-shafts 20. This arrangement will also be explained in the operation section using 2′× 1/16″, 8′×¼″, 16′×½, 32′×1″ and 64′×2″ torsion discs all which are similar to the torsion disc described in FIGS. 1A to 1D but different sizes. FIG. 4B, for comprehension of operation, shows an outline of a mount brace safety enclosure 24. This enclosure secures components such as pivot-bearings or bushings 26 (not shown).

Torsion discs can be made in sections or they can be made as one solid piece such as by molding and or milling. For best performance torsion discs should be exact, symmetrical and have smooth surfaces to minimize wind drag and for smooth operation. Torsion discs should be made strong and durable enough to handle their maximum intended performance without structural breakdown for the length of their intended purpose. Torsion discs can be made in any practical size and in any practical shape and can be made from any practical material and can be made in combinations of materials.

### Operation--FIGS. 1, 2, 3, 4

Because of frequent use in this section horsepower is abbreviated to hp, foot pounds of torque to fpt, and revolutions per minute to rpm.

The function of a torsion disc is to produce torque. The torsion disc described in FIGS. 1A to 1D weighs about 180 pounds. The 120 pounds of outer-rim weight 12 at the 2 foot radius of this torsion disc, while spinning, can become 240 fpt per 1 revolution at the 1 foot radius of this disc. A 48″×⅛″ flat, round, steel disc 10, with no outer-rim weight, weighs about 60 pounds and can, while spinning, produce about 64 fpt per 1 revolution. This torsion disc, spinning at 3360 rpm, can produce about 304 fpt per 1 revolution or about 194 hp.

To achieve this production at this speed, which at 3360 rpm is about 480 miles per hour at the 2 foot radius of this torsion disc, this torsion disc needs about 108 hp. At 1680 rpm this disc needs about 27 hp to produce about 97 hp. At 840 rpm it needs about 7 hp to produce about 48 hp and at 420 rpm this torsion disc needs about 2 hp to produce and sustain about 24 hp. To calculate an approximate minimum amout of power required to obtain and sustain the maximum amount of torque and horsepower any torsion disc can produce at an outer-rim speed of 480 miles per hour, I have put together a simple and basic formula. Basing this formula on 64 hp being required to spin and sustain every 200 pounds of torsion disc and its simulated outer-rim weight at an outer-rim speed of the torsion disc of 480 miles per hour: Basically 24″ or 2 feet divided by the diameter of the torsion disc X the pre-determined amount of fpt the torsion disc can produce + the weight of the torsion disc divided by 200×64=approximate minimum amount of horsepower required.

Using this formula on the torsion disc described in FIGS. 1A to 1D as an example, 24″ divided by 48″=0.5×304 fpt=152+180 pounds=332 divided by 200=1.66×64=106.24 hp. About 57.6 hp of this 106.24 hp is used to sustain this 180 pound torsion disc at an outer-rim speed of 480 miles per hour, or in this case, about 3360 rpm. About 48.64 hp is used to sustain the approximately 152 pounds of simulated outer-rim weight, at 3360 rpm, and at about the 2 foot radius of this disc, which therefore sustains a force of about 304 fpt at the 1 foot radius of this disc, or about 194.38 hp at 3360 rpm, at the out-going drive-shaft of this torsion disc.

The torsion disc shown in FIG. 2 can produce about 46 fpt and needs about 34 hp to produce about 58.8 hp at 6720 rpm. At 3360 rpm it needs about 8.5 hp to produce about 29.4 hp and at 1680 rpm it needs about 2.2 hp to produce and sustain about 14.7 hp. Double the dimensions on this particular torsion disc and it weighs about 480 pounds and needs about 271.4 hp to produce about 736 fpt per 1 revolution or about 470.6 hp at 3360 rpm. At 1620 rpm it needs about 68 hp to produce about 235 hp, and at 840 rpm it needs about 17 hp to produce and sustain about 117.5 hp and so on.

The can-like device described in FIG. 3A comprises two steel discs and a steel cylinder. The two discs can produce about 2 fpt each while spinning. The 45 pound steel cylinder, at the 6″ radius of the spin-axis of this device, can produce about 22.5 fpt. This torsion disc can produce about 26.5 fpt and needs about 36.2 hp to produce about 67.75 hp at 13,440 rpm. At 6720 rpm it needs about 9.1 hp to produce about 33.5 hp and at 3360 rpm it needs about 2.3 hp to produce about 16.75 hp. Double the dimensions on this torsion disc and it weighs about 480 pounds and needs about 290 hp to produce about 424 fpt per 1 revolution, or about 542 hp at 6730 rpm. At 3360 rpm it needs about 72.5 hp to produce about 271 hp. At 1680 rpm it needs about 18.2 hp to produce and sustain about 135.5 hp.

In FIG. 3B a 60 pound version of the devise shown and described in FIG. 3A is shown in an enclosure 24. With this torsion disc needing about 2.3 hp to produce and sustain about 16.75 hp at 3360 rpm, a 3.2 hp at 3360 rpm electric motor 28 is connected to one end of the torsion disc. A generator 30, able to produce about 10,070 watts of power at 3360 rpm is connected at the other end of the disc. At a 90% efficiency ratio this generator needs about 15 hp and the motor needs about 2660 watts to operate at full power. Using a typical automobile battery, for example, to start this example portable generator until the generator is spinning fast enough to power the motor, this generator can, at full speed, power the motor, recharge the battery (not shown), and have over 7000 watts of constant available power.

In FIG. 4A three torsion discs 27 are shown with a gear-ratio or energy conveyance-ratio of 4-1 between 27A and 27. Between 27B and 27C is a gear-ratio of 2-1. For 27C to sustain its 304 fpt per 1 revolution out-put at 3360 rpm, it needs about 168 fpt per 1 revolution applied to it. At 1680 rpm 27B needs about 84 fpt. At 420 rpm 27A needs about 21 fpt to sustain its 304 fpt out-put. By applying about 188 fpt at 420 rpm, or about 15 hp to the drive-shaft of 27A, the out-put power at the drive-shaft of 27C becomes about 305 fpt per 1 revolution at 3360 rpm, or about 195 hp.

A trio of 2″× 1/16″ torsion discs, similar to the discs in FIG. 4A and in a similar arrangement as in FIG. 4A, needs about 2.5 hp to produce about 25 hp. This is more power than the 15 hp needed to power the trio in FIG. 4A. The 195 hp produced by the trio in FIG. 4A is more than needed to power a similar 8″×¼″ trio of discs, which needs about 120 hp to produce about 1570 hp. A similar 16″×½trio of discs needs about 1000 hp to produce about 12,800 hp. A similar trio of 32′×1″ torsion discs needs about 6820 hp to produce about 99,328 hp. A similar trio of 64′×2″ discs needs about 54,480 hp to produce about 794,000 hp. A duet of the 8′×¼″ trio of this particular torsion disc can power three 16′×½″ trios which can power five 32′×1″ trios which can power nine 64′×2″ trios which at 794,000 hp, each can produce and sustain over 500 megawatts of power or more than 4500 megawatts which is more than three times the 1400 megawatt out-put of Hoover Dam or more than twice the 2100 megawatt out-put of Aswan Dam. Torsion discs can be used in any practical combinations.

### Additional Embodiments

The torsion discs described and illustrated in the drawings are basic examples for easy understanding of torsion disc technology. Torsion discs can be made in any practical size and in any practical shape. Basically the more outer-rim weight 12 on a torsion disc the more efficient it is. The torsion disc as described in FIGS. 1A to 1D, with 120 pounds of outer-rim weight, needs about 106.25 hp to produce about 304 fpt per 1 revolution or about 194 hp at 3360 rpm. This is an energy production of about 1.829% at this speed. With 180 pounds of outer-rim weight, rather than 120 pounds, this torsion disc weighs about 240 pounds and needs about 145 hp to produce about 424 fpt per 1 revolution or about 271 hp at 3360 rpm, or an energy production of about 1.874%. A flat, round steel disc, 48″×⅛″ weighing about 60 pounds, needs about 29.44 hp to produce about 40.94 hp at 3360 rpm. This is not a significant amount of energy production at this speed, but at 1680 rpm it needs about 7.5 hp to produce about 20.4 hp. Not as efficient as the disc with outer-rim weight, but still capable of producing a significant amount of energy with the right amount of force applied.

With the use of non-contact bearings 26, such as gas or magnetic, and the use of vacuum-sealed enclosures 24 eliminates all friction during operation of torsion discs and allows a larger variety of shapes or designs, if desired, to be used without concerns about wind-drag.

### Conclusion, Ramification, and Scope

Accordingly, the reader will see that the torsion disc and the technology of this invention can provide an excellent method for producing clean energy. It provides a technology which enables the production of power systems of any practical size which require no fuel to operate. Furthermore, this technology has additional advantages in that
it enables the production of large power plants without the need for dams, fossil fuels, nuclear power, the sun, or the wind to power them, and without concerns about waste disposal;
it enables the production of portable generators which need no fuel to operate and which can be operated in enclosed areas without concerns about dangerous exhaust;
it provides a technology which, though this technology can be used with fuel systems, is an excellent alternative to fuel for automobiles, trucks, boats, ships, or any machine and without the need for any fuel;
it provides an energy-producing device which can be made from a vast variety of plentiful materials;
it provides a technology which, for many practical reasons is an excellent unlimited source of clean energy.

Although the description above contains many specificities, these should not be construed as limiting the scope of the invention but as merely providing illustrations of some of the presently preferred embodiments of this invention.

Thus the scope of the invention should be determined by the appended claims and their legal equivalents, rather than by the examples given.

I claim:

1. In a device capable of producing a significant amount of energy of a type comprising a structure of practical material of practical size and of practical shape.

2. The device of claim 1 wherein produces energy by being spun by means of force application.

3. A technology for producing energy comprising an energy-producing device and a method for using said device for energy production.

4. The technology of claim 3 having a basic formula for calculating an approximate minimum amount of force needed to be applied to a predetermined said device to obtain and sustain maximum energy production from the predetermined said device at a predetermined velocity of the predetermined said device.

5. A method of producing energy, comprising:
(a) providing an energy-producing device,
(b) providing a means of support as to allow said device to spin and to operate sufficiently,
(c) providing a means of energy conveyance,
(d) providing a means of force application,
(e) providing a technology for said device,
whereby said device can produce significantly more energy than applied to said device.
